(19) United States
(12) Patent Application Publication
(10) Pub. No.: US 2015/0330114 A1
(43) Pub. Date: Nov. 19, 2015

(54) POWERED LATCH SYSTEM FOR VEHICLE DOORS AND CONTROL SYSTEM THEREFOR

(71) Applicant: FORD GLOBAL TECHNOLOGIES, LLC, Dearborn, MI (US)

(72) Inventors: H. Paul Tsvi Linden, Oak Park, MI (US); Daniel Carl Bejune, Southfield, MI (US); John Robert Van Wiemeersch, Novi, MI (US); Robert Bruce Kleve, Ann Arbor, MI (US); John Thomas Ricks, Taylor, MI (US); Kosta Papanikolaou, Hungtington Woods, MI (US); Noah Barlow Mass, Ann Arbor, MI (US); Lisa Therese Boran, Northville, MI (US); Ronald Patrick Brombach, Plymouth, MI (US); Jim Michael Weinfurther, Farmington, MI (US)

(73) Assignee: FORD GLOBAL TECHNOLOGIES, LLC, Dearborn, MI (US)

(21) Appl. No.: 14/280,035

(22) Filed: May 16, 2014

Related U.S. Application Data
(63) Continuation-in-part of application No. 14/276,415, filed on May 13, 2014.

(51) Int. Cl. E05B 81/00

(52) U.S. Cl. CPC E05B 81/00

(57) ABSTRACT

A latch system for vehicle doors includes a powered latch including a powered actuator that is configured to unlatch the powered latch. An interior unlatch input feature such as an unlatch switch can be actuated by a user to provide an unlatch request. The system may include a controller that is operably connected to the powered actuator of the powered latch. The controller is configured such that it does not unlatch the powered latch if a vehicle speed is greater than a predefined value unless the interior latch feature is actuated at least two times according to predefined criteria.

### CROSS-REFERENCE TO RELATED APPLICATION

This patent application is a continuation-in-part of U.S. patent application Ser. No. 14/276,415, which was filed on May 13, 2014, entitled “CUSTOMER COACHING METHOD FOR LOCATION OF E-LATCH BACKUP HANDLES” the entire disclosure of which is incorporated herein by reference.

### FIELD OF THE INVENTION

The present invention generally relates to latches for doors of motor vehicles, and more particularly, to a powered latch system and controller that only unlatches the powered latch if predefined operating conditions/parameters are present.

### BACKGROUND OF THE INVENTION

Electrically powered latches (“E-latches”) have been developed for motor vehicles. Known powered door latches may be unlatched by actuating an electrical switch. Actuation of the switch causes an electric motor to shift a pawl to a released/unlatched position that allows a claw of the latch to move and disengage from a striker to permit opening of the vehicle door. E-latches may include a mechanical emergency/backup release lever that can be manually actuated from inside the vehicle to unlatch the powered latch if the powered latch fails due to a loss of electrical power or other malfunction.

### SUMMARY OF THE INVENTION

One aspect of the present invention is a latch system for vehicle doors. The latch system includes a powered latch including a powered actuator that is configured to unlatch the powered latch. An interior unlatch input feature such as an unlatch switch can be actuated by a user to provide an unlatch request.

The system may include a controller that is operably connected to the powered latch. The controller may be configured (i.e. programmed) such that it does not unlatch the powered latch if a vehicle speed is greater than a predefined value unless the interior latch feature is actuated at least two times within a predefined period of time.

In addition to the unlatch switch, the latch system may include an unlock input feature such as an unlock switch mounted on an inner side of a vehicle door that can be actuated by a user to provide an unlock request. The controller may be in communication with both the interior unlatch switch and the unlock switch. The controller may be configured to cause the powered latch to unlatch if a total of at least three discreet inputs in any combination are received from the interior unlatch input feature and/or the unlock input feature within a predefined time interval. The at least three discreet inputs are selected from a group including an unlatch request and an unlock request.

The system may include a control module that is configured to detect a crash event and cause airbags and/or other passenger constraints to be deployed. The controller may be configured to communicate with the control module by only a selected one of a digital data communication network and one or more electrical conductors extending between the controller and the control module. The controller is configured to operate in a first mode wherein a single actuation of the interior unlatch input feature may be sufficient to unlatch the powered latch, and a second mode in which the controller requires at least two discreet actuations of the interior unlatch input feature within a predefined time interval to unlatch the powered latch. The controller is configured to utilize the second mode if communication with the control module is interrupted or lost.

The controller may be configured to communicate with the control module utilizing a digital data communication network and one or more electrical conductors extending between the controller and the control module. The controller may be configured to operate in a first mode wherein a single actuation of the interior unlatch input feature may be sufficient to unlatch the powered latch, and a second mode in which the controller requires at least two discreet actuations of the interior unlatch input feature within a predefined time interval to unlatch the powered latch. The controller utilizes the first operating mode if the controller is able to communicate with the control module utilizing at least one of the data communications network and the electrical conductors. The controller utilizes the second operating mode if the controller is unable to communicate properly according to predefined criteria with the control module utilizing either the data communications network or the electrical conductors.

The powered latch may be configured to be connected to a main vehicle electrical power supply, and the powered latch may include a secondary electrical power supply capable of providing sufficient electrical power to actuate the powered actuator if the main vehicle electrical power supply is interrupted. The controller may be operably connected to the powered actuator. The controller is configured to operate in first and second modes. In the first mode, a single actuation of the interior unlatch input feature is sufficient to unlatch the powered latch. In the second mode, the controller requires at least two discreet actuations of the interior unlatch input feature within a predefined time interval to unlatch the powered latch. The controller is configured to utilize the second operating mode if the main vehicle electrical power supply is interrupted.

The controller may be configured to communicate with a control module utilizing a digital data communication network and one or more electrical conductors extending between the controller and the control module. The controller may be configured to operate in first and second modes. In the first mode, a single actuation of the interior unlatch input feature may be sufficient to unlatch the powered latch. In the second mode, the controller is configured to require at least two discreet actuations of the interior unlatch input feature within a predefined time interval to unlatch the powered latch. The controller is configured to utilize the second operating mode if communication with the control module utilizing the digital data communication network is interrupted, even if the controller maintains communication with the control module utilizing the one or more electrical conductors.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a partially schematic view of an interior side of a vehicle door having a powered latch according to one aspect of the present invention;

FIG. 2 is a schematic view of a powered latch; and

FIG. 3 is a diagram showing a latch system according to one aspect of the present invention.

### DETAILED DESCRIPTION OF THE PREFERRED EMBODIMENTS

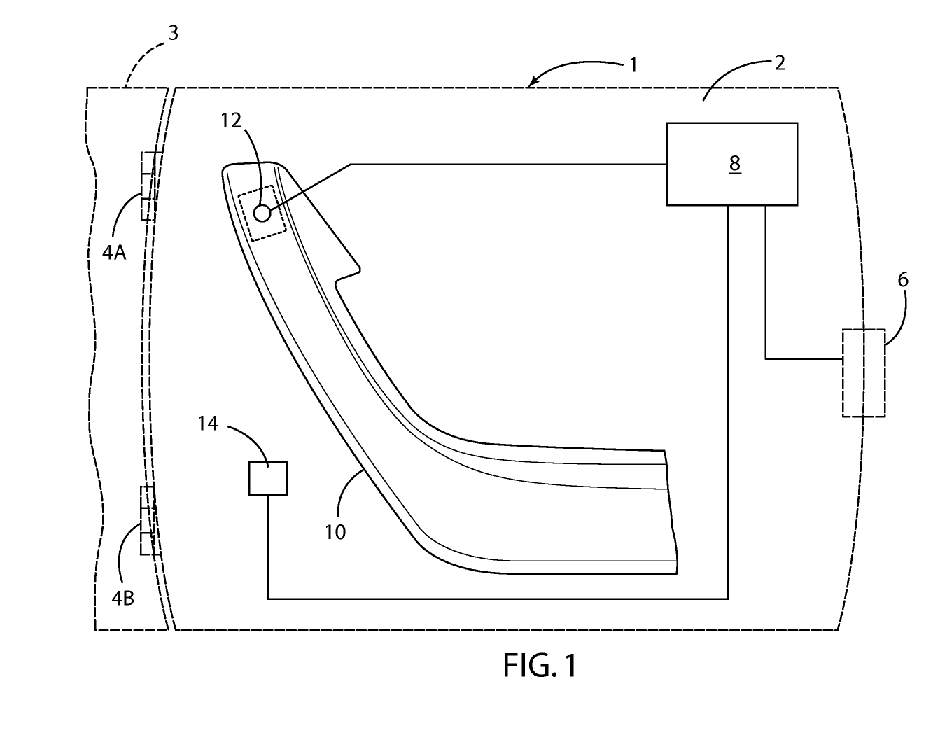

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a door 1 includes a door structure 2 that may be movably mounted to a vehicle structure 3 in a known manner utilizing hinges 4A and 4B Door 1 may also include an electrically powered latch that is configured to selectively retain the door 1 in a closed position. The powered latch 6 is operably connected to a controller 8. As discussed in more detail below, the controller 8 may comprise an individual control module that is part of the powered latch 6, and the vehicle may include a powered latch 6 at each of the doors of a vehicle. Door 2 may also include an interior unlatch input feature such as an unlatch switch 12 that is operably connected to the controller 8. In use, a user actuates the interior unlatch switch 12 to generate an unlatch request to the controller 8. As also discussed in more detail below, if the latch 6 is unlatched and/or certain predefined operating perimeters or conditions are present, controller 8 generates a signal causing powered latch 6 to unlatch upon actuation of interior unlatch switch 12. Door 2 may also include an unlock input feature such as an unlock switch 14 that is mounted to the door 2. The unlock switch 14 is operably connected to the controller 8. Controller 8 may be configured to store a door or latch lock or unlock state that can be changed by actuation of unlock switch 14. Controller 8 may be configured (e.g. programmed) to deny an unlatch request generated by actuation of the interior unlatch switch 12 if the controller 8 determines that the powered latch 6 is in a locked state. Controller 8 is preferably a programmable controller that can be configured to unlatch powered latch 6 according to predefined operating logic by programming controller 8. However, controller 8 may comprise electrical circuits and components that are configured to provide the desired operating logic.

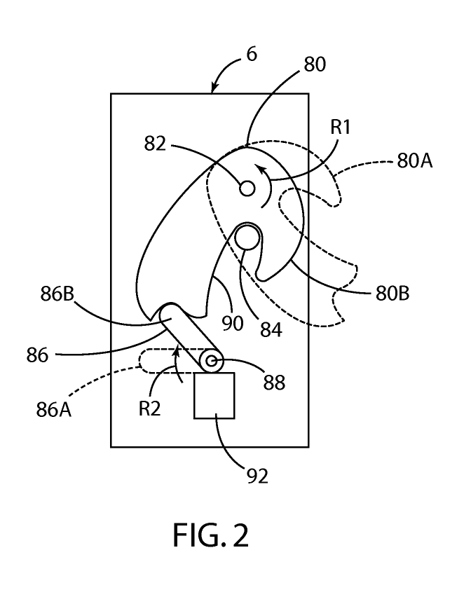

With further reference to FIG. 2, powered latch 6 may include a claw 80 that pivots about a pivot 82 and a pawl 86 that is rotatably mounted for rotation about a pivot 88. Pawl 86 can move between a disengaged or unlatched position 86A and a latched or engaged configuration or position 86B. In use, when door 1 is open, claw 80 will typically be in an extended position 80A. As the door 1 is closed, surface 90 of claw 80 comes into contact with a striker 84 that is mounted to the vehicle structure. Contact between striker 84 and surface 90 of claw 80 causes the claw 80 to rotate about pivot 82 in the direction of the arrow “R1” until the claw 80 reaches the closed position 80B. When claw 80 is in the closed position 80B, and pawl 86 is in the engaged position 86B, pawl 86 prevents rotation of claw 80 to the open position 80A, thereby preventing opening of door 1. Claw 80 may be biased by a spring or the like for rotation in a direction opposite the arrow R1 such that the claw 80 rotates to the open position 80A unless pawl 86 is in the engaged position 86B. Pawl 86 may be biased by a spring or the like in the direction of the arrow R2 such that pawl 86 rotates to the engaged position 86B as claw 80 rotates to the closed position 80B as striker 84 engages claw 80 as door 1 is closed. Latch 6 can be unlatched by rotating pawl 86 in a direction opposite the arrow R2 to thereby permit rotation of claw 80 from the closed position 80B to the open position 80A. A powered actuator such as an electric motor 92 may be operably connected to the pawl 86 to thereby rotate the pawl 86 to the disengaged or unlatched position 86A. Controller 30 can unlatch powered latch 6 to an unlatched configuration or state by causing powered actuator 92 to rotate pawl 86 from the latched or engaged position 86B to the unlatched configuration or position 86A. However, it will be understood that various types of powered latches may be utilized in the present invention, and the powered latch 6 need not include the claw 80 and powered pawl 86 as shown in FIG. 2. For example, powered actuator 92 could be operably interconnected with the claw 80 utilizing a mechanical device other than pawl 86 to thereby shift the powered latch 6 between latched and unlatched states. In general, vehicle door 1 can be pulled open if powered latch 6 is in an unlatched state, but the powered latch 6 retains the vehicle door 1 in a closed position when the powered latch 6 is in a latched state or configuration.

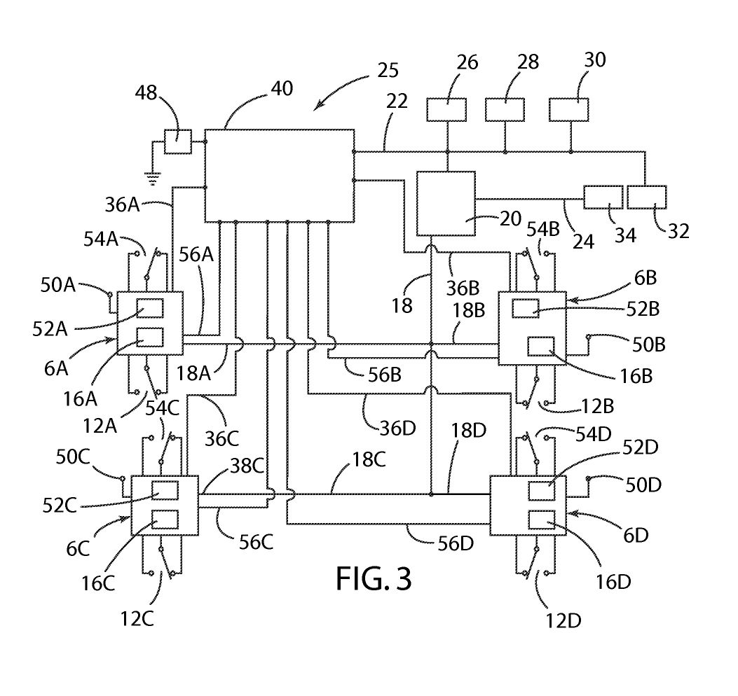

With further reference to FIG. 3, a latch system 25 may include a driver's side front powered latch 6A, a passenger side front powered latch 6B, a passenger side rear powered latch 6C and a rear passenger side powered latch 6D. The powered latches 6A-6D are configured to selectively retain the corresponding driver and passenger front and rear doors of a vehicle in a closed position. Each of the powered latches 6A-6D may include a controller 16A-16D, respectively, that is connected to a medium speed data network 18 including network lines 18A-18D. Controllers 16A-16D are preferably programmable controllers, but may comprise electrical circuits that are configured to provide the desired operating logic. The data network 18 may comprise a Medium Speed Controller Area Network (“MS-CAN”) that operates according to known industry standards. Data network 18 provides data communication between the controllers 16A-16D and a digital logic controller (“DLC”) gateway 20. The DLC gateway 20 is operably connected to a first data network 22, and a second data network 24. First data network 22 may comprise a first High Speed Controller Area Network (“HS1-CAN”), and the second data network 24 may comprise a second High Speed Controller Area Network (“HS2-CAN”). The data networks 22 and 24 may operate according to known industry standards. The first data network 22 is connected to an Instrument Panel Cluster (“IPC”) 26, a Restraints Control Module (“RCM”) 28, and a Power Control Module (“PCM”) 30. The RCM 28 utilizes data from acceleration sensors to determine if a crash event has occurred. The RCM 28 may be configured to deploy passenger restraints and/or turn off a vehicle's fuel supply in the vent a crash is detected. The first high speed data network 22 may also be connected to a display screen 32 that may be positioned in a vehicle interior to provide visual displays to vehicle occupants. The second high speed data network 24 is operably connected to antilock brakes (“ABS”) module 34 that includes sensors that measure a speed of the vehicle.

System 25 also includes a body control module 40 that is connected to the first high speed data network 22. The body control module 40 is also operably connected to the powered latches 6A-6D by data lines 36A-36D. Controllers 16A-16D may also be directly connected (“hardwired”) to control module 40 by electrical conductors such as wires 56A-56D, respectively. Wires 56A-56D may provide a redundant data connection between controllers 16A-16D and controller 40, or the wires 56A-56D may comprise the only data connection between controllers 16A-16D and controller 40. Control module 40 may also be operably interconnected to sensors (not shown) that signal the control module 40 if the vehicle doors are ajar. Control module 40 is also connected to a main vehicle electrical power supply such as a battery 48. Each of the powered latches 6A-6D may be connected to main vehicle power supply 48 by connectors 50A-50D. The powered latches 6A-6D may also include back up power supplies 52 that can be utilized to actuate the powered actuator 92 in the event the power supply from main vehicle power supply 48 is interrupted or lost. The backup power supplies 52 may comprise capacitors, batteries, or other electrical energy storage devices. In general, the backup power supplies 52 store enough electrical energy to provide for temporary operation of controllers 16A-16d, and to actuate the powered actuators 92 a plurality of times to permit unlatching of the vehicle doors in the event the main power supply/battery 48 fails or is disconnected.

Each of the powered latches 6A-6D is also operably connected to an interior unlatch switch 12A-12D, respectively, that provide user inputs (unlatch requests). The powered latches 6A-6D are also operably connected to an exterior unlatch switches 54A-54D, respectively. Controllers 16A-16D are also operably connected to unlock switches 14 (FIG. 1). Controllers 16A-16D may be configured to store the Lock Status (“Locked” or “Unlocked”) and to utilize the Lock Status for control of powered latches 6A-6D as shown below in Tables 1 and 2.

The controller 40 and individual controllers 16A-16D may be configured to unlatch the powered latches based on various user inputs and vehicle operating perimeters as shown in Table 1:

TABLE 1
MS-CAN

| (First Data | | | UNLATCH Operation per Door | | | | | |
|---|---|---|---|---|---|---|---|---|
| Network 18) | | | Normal Non-Crash Behavior (Delay Operation to Validate Input was not from a Crash Event) | | | | | |
| Or VPWR | | | | | Interior Rear Door | | Interior Rear Door | |
| (Main Vehicle | | LOCK | Exterior Any | Interior Front | (First Geographic Region) | | (Second Geographic Region) | |
| Power 48) | SPEED | STATUS | Door | Door | Child Lock ON | Child Lock OFF | Child Lock ON | Child Lock OFF |
| OK | Speed < | Locked & | Powered | Unlatch switch | Unlatch switch | Unlatch switch | Unlatch switch | Unlatch switch |
| | 3 kph | Alarm | Latch 6 Not | 12 actuated 2 | 12 actuated | 12 actuated 2 | 12 actuated 2 | 12 actuated 2 |
| | | Armed | Unlatched | times within | twice within | times within | times within | times within |
| | | | | 3 seconds | 3 seconds | 3 seconds | 3 seconds | 3 seconds |
| | | Locked | Powered | Single | Powered | Unlock switch | Powered | Single |
| | | | Latch 6 Not | actuation | Latch 6 Not | 14 actuated to | Latch 6 Not | actuation |
| | | | Unlatched | of Unlatch | Unlatched | unlock, then | Unlatched | of Unlatch |
| | | | | switch 12 | | Unlatch switch | | switch 12 |
| | | | | | | 12 actuated 2 | | |
| | | | | | | times within | | |
| | | | | | | 3 seconds | | |
| | | Unlocked | Single | Single | Powered | Single Unlatch | Powered | Single |
| | | | actuation | actuation | Latch 6 Not | | Latch 6 Not | actuation |
| | | | of Unlatch | of Unlatch | Unlatched | | Unlatched | of Unlatch |
| | | | switch 12 | switch 12 | | | | switch 12 |
| | 3 kph < | ANY | Powered | Unlock switch | Powered | Unlock switch | Powered | Unlock switch |
| | Speed < | | Latch 6 Not | 14 actuated to | Latch 6 Not | 14 actuated to | Latch 6 Not | 14 actuated to |
| | 8 kph | | Unlatched | unlock, then | Unlatched | unlock, then | Unlatched | unlock, then |
| | | | | Unlatch switch | | Unlatch switch | | Unlatch switch |
| | | | | 12 actuated 2 | | 12 actuated 2 | | 12 actuated 2 |
| | | | | times within | | times within | | times within |
| | | | | 3 seconds | | 3 seconds | | 3 seconds |
| | Speed > | ANY | Powered | Unlock switch | Powered | Unlock switch | Powered | Unlock switch |
| | 8 kph | | Latch 6 Not | 14 actuated to | Latch 6 Not | 14 actuated to | Latch 6 Not | 14 actuated to |
| | | | Unlatched | unlock, then | Unlatched | unlock, then | Unlatched | unlock, then |
| | | | | Unlatch switch | | Unlatch switch | | Unlatch switch |
| | | | | 12 actuated 2 | | 12 actuated 2 | | 12 actuated 2 |
| | | | | times within | | times within | | times within |
| | | | | 3 seconds | | 3 seconds | | 3 seconds |
| Lost | Unknown | Unknown | Last Known | Unlock switch | Unlock switch | Unlock switch | Unlock switch | Unlock switch |
| | | | State | 14 actuated to | 14 actuated to | 14 actuated to | 14 actuated to | 14 actuated to |
| | | | | unlock, then | unlock, then | unlock, then | unlock, then | unlock, then |
| | | | | Unlatch switch | Unlatch switch | Unlatch switch | Unlatch switch | Unlatch switch |
| | | | | 12 actuated 2 | 12 actuated 2 | 12 actuated 2 | 12 actuated 2 | 12 actuated 2 |
| | | | | times within | times within | times within | times within | times within |
| | | | | 3 seconds | 3 seconds | 3 seconds | 3 seconds | 3 seconds |

TABLE 2

| MS-CAN | | | | | | |
|---|---|---|---|---|---|---|
| (First Data | | | | | | |
| Network 18) | | | UNLATCH Operation per Door | | | |
| Or VPWR | | | Crash Behavior (Operation After Crash Event Recognized) | | | |
| (Main Vehicle | | LOCK | | | Interior Door (First and Second Geographic Region) | |
| Power 48) | SPEED | STATUS | Exterior Any Door | Interior Front Door | Child Lock ON | Child Lock OFF |
| OK | Speed < | Locked & | State Not Allowed (RCM 28 Off when Security System Armed) | | | |
| | 3 kph | Alarm | | | | |
| | | Armed | | | | |
| | | Locked | Powered | Unlock switch | Powered | Unlock switch |
| | | | Latch 6 Not | 14 actuated to | Latch 6 Not | 14 actuated to |
| | | | Unlatched | unlock, then | Unlatched | unlock, then |
| | | | | Unlatch switch | | Unlatch switch |
| | | | | 12 actuated 2 | | 12 actuated 2 |
| | | | | times within | | times within |
| | | | | 3 seconds | | 3 seconds |
| | | Unlocked | Powered | Unlock switch | Powered | Unlock switch |
| | | | Latch 6 Not | 14 actuated to | Latch 6 Not | 14 actuated to |
| | | | Unlatched | unlock, then | Unlatched | unlock, then |
| | | | | Unlatch switch | | Unlatch switch |
| | | | | 12 actuated 2 | | 12 actuated 2 |
| | | | | times within | | times within |
| | | | | 3 seconds | | 3 seconds |
| | 3 kph < | ANY | Powered | Unlock switch | Powered | Unlock switch |
| | Speed < | | Latch 6 Not | 14 actuated to | Latch 6 Not | 14 actuated to |
| | 8 kph | | Unlatched | unlock, then | Unlatched | unlock, then |
| | | | | Unlatch switch | | Unlatch switch |
| | | | | 12 actuated 2 | | 12 actuated 2 |
| | | | | times within | | times within |
| | | | | 3 seconds | | 3 seconds |
| | Speed > | ANY | Powered | Unlock switch | Powered | Unlock switch |
| | 8 kph | | Latch 6 Not | 14 actuated to | Latch 6 Not | 14 actuated to |
| | | | Unlatched | unlock, then | Unlatched | unlock, then |
| | | | | Unlatch switch | | Unlatch switch |
| | | | | 12 actuated 2 | | 12 actuated 2 |
| | | | | times within | | times within |
| | | | | 3 seconds | | 3 seconds |
| Lost | Unknown | Unknown | Powered | Unlock switch | Unlock switch | Unlock switch |
| | | | Latch 6 Not | 14 actuated to | 14 actuated to | 14 actuated to |
| | | | Unlatched | unlock, then | unlock, then | unlock, then |
| | | | | Unlatch switch | Unlatch switch | Unlatch switch |
| | | | | 12 actuated 2 | 12 actuated 2 | 12 actuated 2 |
| | | | | times within | times within | times within |
| | | | | 3 seconds | 3 seconds | 3 seconds |

As shown in tables 1 and 2, the controllers 16A-16C and/or control module 40 may be configured (e.g. programmed) to control unlatching of powered latches 6A-6D according to different criteria as required for different geographic areas. Additionally, the control module may be configured to control unlatching behavior differently when a crash even condition is present as compared to normal or non-crash conditions. Table 1 represents an example of Unlatching Behavior during normal (non-crash) conditions whereas Table 2 represents example behavior during Crash Conditions. The controllers 16A-16C and/or control module 40 may be configured to recognize a Crash Condition by monitoring the data network for a crash signal from the RCM 28 and/or by monitoring various other direct signal inputs from the RCM 28. As discussed below, the RCM 28 may be configured to determine if a crash event has occurred and generate one or more crash signals that may be communicated to the latch controllers 16A-16C and/or control module 40. Upon recognizing that a crash condition exists, the controller 16A-16C and/or control module 40 may also be configured to initiate a timer and to disallow any unlatching operation for a predefined time interval (e.g. 3 seconds) before resuming the crash behavior (control logic or operating mode) described in Table 2.

The controllers 16A-16D and/or control module 40 may be configured to provide a first operating mode wherein the powered latches 6A-6D are unlatched if interior unlatch switch 12 is actuated once. The system may also include a second operating mode. When the system is in the second operating mode, the interior unlatch switch 12 must be actuated at least two times within a predefined time period (e.g. 3 seconds). For example, this operating mode may be utilized when the vehicle is locked and the vehicle security system is armed.

As discussed above, the control module 40 may be operably interconnected with the controllers 16A-16D by data network 8 and/or data lines 36A-36D. Control module 40 may also be operably interconnected with the controllers 16A-16D by “hard” lines 56A-56D. The system 25 may also be configured such that the control module 40 is connected to the controllers 16A-16D only by network 18, only data lines 36A-36D, or only by conductors 38A-38D.

During normal operation, or when the vehicle is experiencing various operating failures, the system 25 may also be configured to control the powered latches 6A-6D based on various operating parameters and/or failures within the vehicles electrical system, the data communication network, the hardwires, and other such parameters or events.

For example, during normal operation the system 25 may be configured to unlatch powered latches 6A-6D if interior unlatch switch 12 is actuated at least once and if the vehicle is traveling below 3 kph or other predefined speed. The speed may be determined utilizing suitable sensors (e.g. sensors in ABS module 34). If the vehicle is traveling at or below 3 kph, the powered latches 6A-6D may also be unlatched if exterior unlatch switch 54 is actuated one or more times while unlocked. However, the controllers 16A-16D may be configured such that if the vehicle is traveling above 3 kph, the latches 6A-6D cannot be unlatched by actuating exterior unlatch switches 54A-54D. Likewise, if the vehicle is traveling below 3 kph and while locked and armed, the system 25 may be configured to unlatch powered latches 6A-6D if interior unlatch switches 12A-12D are actuated at least two times within a predefined time interval (e.g. 3 seconds).

The system 25 may be configured to debounce interior unlatch switches 12A-12D and/or exterior unlatch switches 54A-54D at a first time interval (e.g. 35 ms) during normal vehicle operation. However, the debounce may be performed at longer time intervals (100-150 ms) if the vehicle is in gear (e.g. PCM 30 provides a signal indicating that the vehicle transmission gear selector is in a position other than “Park” or “Neutral”).

Furthermore, the system 25, in crash operation for example, may be configured to unlatch the powered latches 6A-6D based on multiple inputs from interior unlatch switch 12 and/or interior unlock switch 14. Specifically, the controllers 16A-16D may be configured to provide a three-input mode or feature and unlatch powered latches 6A-6D if three separate inputs from interior unlatch switches 12A-12D and interior unlock switches 14A-14D are received within a predefined time interval (e.g. 3 seconds or 5 seconds) in any sequence. For example, controllers 16A-16D may be configured such that three actuations of interior unlatch switch 12 or three actuations of unlock switch 14 within the predefined time interval results in unlatching of powered latches 6A-6D. Also, actuation of unlock switch 14 followed by two actuations of unlatch switch 12 within the predefined time period could be utilized as a combination of inputs that would unlatch powered latches 6A-6D. Similarly, two actuations of the unlatch switch 12 followed by a single actuation of unlock switch 14 within the predefined time period may be utilized as an input that causes the powered latches 6A-6D to unlatch. Still further, two actuations of unlock switch 14 followed by a single actuation of interior unlatch switch 12 could also be utilized as a combination of inputs resulting in unlatching of powered latches 6A-6D. Thus, three inputs from unlatch switch 12 and/or unlock switch 14 in any combination or sequence within a predefined time interval may be utilized by the system 25 to unlatch powered latches 6A-6D. This control scheme prevents inadvertent unlatching of powered latches 6A-6D, but also permits a user who is under duress to unlatch the doors if three separate inputs in any sequence or combination are provided. Additionally, system 25 may be configured such that the three-input mode/feature is active only under the presence of certain conditions. For example, the system 25 (e.g. controllers 16A-16D) may be configured to provide a three-input mode-feature if a crash condition is present and/or loss of data network condition occurs as recognized by the controllers 16A-16D.

If the system 25 includes only data network connections 36A-36D, or only includes “hardwire” lines 56A-56D, the controllers 16A-16D may be configured to require a plurality of actuations of interior unlatch switch 12 if either the network or hardwire connectivity with RCM 28 is lost. If the controllers 16A-16D cannot communicate with the RCM 28, the controllers 16A-16D do not “know” the status of RCM 28, such that the controllers 16A-16D cannot “know” if a crash or fuel cut-off event has occurred. Accordingly, the controllers 16A-16D can be configured to default to require multiple actuations of interior unlatch switches 12A-12D in the event communication with RCM 28 (or other components) is lost to insure that the powered latches 6A-6D are not inadvertently unlatched during a crash event that was not detected by the system due to a loss of communication with the RCM 28. Similarly, if the network connectivity is lost, the controllers 16A-16D will be unable to “know” the vehicle speed and may default to utilizing the last known valid vehicle speed. Alternatively, the controllers 16A-16D may be configured instead to assume by default that the vehicle speed is less than 3 kph if network connectivity is lost. This may be utilized in the unlatch operation behavior from processing the exterior unlatch switches 54A-54D and/or the interior switches. It will be understood that controllers 16A-16D may be configured to determine if network connectivity has been “lost” for purposes of controlling latch operations based on predefined criteria (e.g. an intermittent data connection) that does not necessarily require a complete loss of network connectivity.

Similarly, if the system 25 includes both network connections 36A-36D and “hard” lines 56A-56D, the controllers 16A-16D may be configured to default to a mode requiring multiple actuations of interior unlatch switch 12 if both the data and hardwire connections are disrupted or lost. However, if either of the data or hardwire connections remain intact, the controllers 16A-16D can be configured to require only a single actuation of interior unlatch switch 12, provided the vehicle is known to be below a predefined maximum allowable vehicle speed and other operating parameters that would otherwise trigger a requirement for multiple actuations of interior unlatch switches 12A-12D.

Furthermore, the controllers 16A-16D may be configured to default to a mode requiring multiple actuations of interior unlatch switches 12A-12D if the power to latches 6A-6D from main vehicle power supply 48 is interrupted, even if the network connectivity with RCM 28 remains intact. This may be done to preserve the backup power supplies 52A-52D. Specifically, continued monitoring of the data network by controllers 16A-16D will tend to drain the backup power supplies 52A-52D, and the controllers 16A-16D may therefore be configured to cease monitoring data from data lines 36A-36D and/or network 18 in the event power from main vehicle power supply 48 is lost. Because the controllers 16A-16D cease monitoring the data communication upon failure of main power supply 48, the individual controllers 16A-16D cannot determine if a crash event has occurred (i.e. the controllers 16A-16D will not receive a data signal from RCM 28), and the controllers 16A-16D therefore default to require multiple actuations of interior unlatch switches 12A-12D to insure that the latches 6A-6D are not inadvertently unlatched during a crash event that was not detected by controllers 16A-16D. Additionally, in such cases the controllers 16A-16D will likewise be unable to determine vehicle speed and may be configured (e.g. programmed) to default to utilizing the last known valid vehicle speed. Alternatively, the controllers 16A-16D may instead be configured to “assume” by default that the vehicle speed is less than a predefined speed (e.g. 3 kph). These defaults, assumptions may be utilized in the unlatch operation behavior when processing inputs from the exterior unlatch switches 54A-54D and/or the interior switches 12A-12D.

Furthermore, the system may be configured to default to require multiple actuations of interior unlatch switches 12A-12D in the event the data network connection (network 18 and/or data lines 36A-36D) connectivity between the controllers 16A-16D and RCM 28 is lost. Specifically, even if the “hard” lines 56A-56D remain intact, the data transfer rate of the hard lines 56A-56D is significantly less than the data transfer rate of the network 18 and data lines 36A-36D, such that the controllers 16A-16D may not receive crash event data from RCM 28 quickly enough to shift to a mode requiring multiple actuations of interior unlatch switches 12A-12D if the crash data can only be transmitted over the hard lines 38A-38D. Thus, defaulting to a mode requiring multiple actuations of interior unlatch switches 12A-12D upon failure of data communications (network 18 and/or data lines 36A-36D) even if the hardwire communication lines remain intact insures that the powered latches 6A-6D are not inadvertently unlatched during a crash event that was detected by the controllers 16A-16D only after a delay due to a slower data transfer rate. Similarly, in such cases where the controllers 16A-16D are not communicating over the data network, they will be unable to “know” the vehicle speed as well and my default to utilizing the last known valid vehicle speed. Alternatively, the controllers 16A-16D may instead be configured to “assume” by default that the vehicle speed is less than a predefined speed (e.g. 3 kph). These defaults/assumptions may be utilized in the unlatch operation behavior when processing inputs from the exterior unlatch switches 54A-54D and/or the interior switches 12A-12D.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A latch system for vehicle doors, the latch system comprising:
a powered latch including a powered actuator that is configured to unlatch the powered latch;
an interior unlatch input feature that can be actuated by a user to provide an unlatch request;
a controller operably connected to the powered latch, wherein the controller is configured such that it does not unlatch the powered latch if a vehicle speed is greater than a predefined value unless the interior unlatch feature is actuated at least two times according to predefined criteria.

2. The latch system of claim 1, wherein:
the predefined criteria comprises actuating the interior unlatch input feature at least two times within a predefined time interval.

3. The latch system of claim 1, wherein
the predefined value of the vehicle speed is about three kilometers per hour.

4. The latch system of claim 1, including:
an exterior unlatch input feature; and wherein:
the predefined value comprises a first predefined value, and wherein actuation of the exterior unlatch input feature does not unlatch the powered latch unless the vehicle speed is less than a second predefined value.

5. The latch system of claim 4, wherein;
the first predefined value is equal to the second predefined value.

6. The latch system of claim 1, wherein:
the interior unlatch input feature comprises a switch that is debounced at a first frequency if the interior unlatch switch is actuated at a vehicle speed that is less than the predefined value, and the unlatch switch is debounced at a second frequency that is significantly lower than the first frequency if the vehicle speed is above the predefined value.

7. A latch system for vehicle doors, the latch system comprising:
a powered latch including a powered actuator that is configured to unlatch the powered latch;
an interior unlatch input feature that can be actuated by a user to provide an unlatch request;
an unlock input feature that can be actuated by a user to provide an unlock request; and
a controller in communication with the interior unlatch input feature and the unlock input feature, wherein the controller causes the powered latch to unlatch if a total of at least three discrete inputs in any combination are received from the interior unlatch input feature and/or the unlock input feature within a predefined time interval, wherein the at least three discrete inputs are selected from the group consisting of an unlatch request and an unlock request.

8. The latch system of claim 7, wherein:
the predefined time interval is five seconds.

9. The latch system of claim 7, wherein:
the at least three inputs comprises three unlatch requests or three unlock requests.

10. A latch system for vehicle doors, the latch system comprising:
a powered latch including a powered actuator that is configured to unlatch the powered latch;
an interior unlatch input feature that can be actuated by a user to provide an unlatch request;
a control module configured to detect a crash event; and
a controller that is configured to communicate with the control module by only a selected one of a digital data communication network and one or more electrical conductors extending between the controller and the control module, wherein the controller is configured to operate in a first operating mode wherein a single actuation of the interior unlatch input feature may be sufficient to unlatch the powered latch, and a second operating mode in which the controller requires at least two discrete actuations of the interior unlatch input feature within a predefined time interval to unlatch the powered latch, and wherein the controller utilizes the second operating mode if communication with the control module is interrupted.

11. The latch system of claim 10, wherein:
the controller utilizes the second operating mode if communication with the control module is lost for more than a predefined second time interval.

12. The latch system of claim 11, wherein:
the predefined second time interval is significantly less than 1.0 seconds.

13. The latch system of claim 10, wherein:
The interior unlatch input feature comprises a switch that can be manually actuated by a user.

14. A latch system for vehicle doors, the latch system comprising:
a powered latch including a powered actuator that is configured to unlatch the powered latch;
an interior unlatch input feature that can be actuated by a user to provide an unlatch request;
a control module configured to detect a crash event;
a controller that is configured to communicate with the control module utilizing a digital data communications network and one or more electrical conductors extending between the controller and the control module, and
wherein the controller is configured to operate in a first operating mode wherein a single actuation of the interior unlatch input feature may be sufficient to unlatch the powered latch, and a second operating mode in which the controller requires at least two discrete actuations of the interior unlatch input feature within a predefined time interval to unlatch the powered latch, and wherein the controller utilizes the first operating mode if the controller is able to communicate with the control module utilizing at least one of the data communications network and the electrical conductors, and wherein the controller utilizes the second operating mode if the controller is unable to communicate with the control module utilizing either the data communications network or the electrical conductors.

15. The latch system of claim 14, wherein:
the controller is configured to determine that a loss of communications has occurred if communication does not occur for at least a predefined period of time.

16. A latch system for vehicle doors, the latch system comprising:
a powered latch including a powered actuator that is configured to unlatch the powered latch and wherein the powered latch is configured to be connected to a main vehicle electrical power supply, the powered latch including a secondary electrical power supply capable of providing sufficient electrical power to actuate the powered actuator if the main vehicle electrical power supply is interrupted;
an interior unlatch input feature that can be actuated by a user to provide an unlatch request; and wherein:
a controller that is operably connected to the powered actuator, wherein the controller is configured to operate in a first operating mode wherein a single actuation of the interior unlatch input feature may be sufficient to unlatch the powered latch, and a second operating mode in which the controller requires at least two discrete actuations of the interior unlatch input feature within a predefined time interval to unlatch the powered latch, and wherein the controller utilizes the second operating mode if a supply of electrical power from the main vehicle electrical power supply is interrupted.

17. The latch system of claim 16, including:
a control module configured to detect a crash event; and wherein:
the controller is configured to communicate with the control module, and wherein the controller is configured to utilize the second operating mode if the control module detects a crash event.

18. A latch system for vehicle doors, the latch system comprising:
a powered latch including a powered actuator that is configured to unlatch the powered latch;
an interior unlatch input feature that can be actuated by a user to provide an unlatch request;
a control module configured to detect a crash event; and
a controller that is configured to communicate with the control module utilizing a digital data communication network and one or more electrical conductors extending between the controller and the control module, wherein the controller is configured to operate in a first operating mode wherein a single actuation of the interior unlatch input feature may be sufficient to unlatch the powered latch, and a second operating mode in which the controller requires at least two discrete actuations of the interior unlatch input feature within a predefined time interval to unlatch the powered latch, and wherein the controller utilizes the second operating mode if communication with the control module utilizing the digital data communication network is interrupted even if the controller maintains communication with the control module utilizing the one or more electrical conductors.

19. The latch system of claim 1, wherein:
the powered latch system includes at least four powered latches including a pair of front latches that are configured to selectively retain a pair of front doors in closed positions and a pair of rear latches that are configured to selectively retain a pair of rear doors in closed positions, and wherein each powered latch includes a programmable latch controller that can be programmed to unlatch the powered latches according to selected predefined criteria, and wherein the four programmable latch controllers define locked and unlocked states, and wherein the programmable latch controllers of the rear latches are configured to provide a child lock feature such that the programmable controllers of the rear doors require the interior input feature to be actuated at least two times within a predefined time interval if the rear latches are in a locked state.

20. A latch system for vehicle doors, the latch system comprising:
a powered latch including a powered actuator that is configured to unlatch the powered latch and wherein the powered latch is configured to be connected to a main vehicle electrical power supply, the powered latch including a secondary electrical power supply capable of providing sufficient electrical power to actuate the powered actuator if the main vehicle electrical power supply is interrupted;
an interior unlatch input feature that can be actuated by a user to provide an unlatch request; and wherein:
a control module configured to detect a crash event;
a controller that is operably connected to the control module and to the powered actuator, wherein the controller is configured to operate in a first operating mode wherein a single actuation of the interior unlatch input feature may be sufficient to unlatch the powered latch, and a second operating mode in which the controller requires at least two discrete actuations of the interior unlatch input feature within a predefined time interval to unlatch the powered latch, and wherein the controller utilizes the second operating mode if a crash event has occurred.
